(19) United States
(12) Patent Application Publication
(10) Pub. No.: US 2025/0310948 A1
(43) Pub. Date: Oct. 2, 2025

(54) USER EQUIPMENT AND METHOD FOR BEAM MANAGEMENT IN SIDELINK COMMUNICATION

(71) Applicant: GUANGDONG OPPO MOBILE TELECOMMUNICATIONS CORP., LTD., Dongguan (CN)

(72) Inventor: Huei-Ming LIN, Taiwan (CN)

(21) Appl. No.: 19/238,667

(22) Filed: Jun. 16, 2025

Related U.S. Application Data
(63) Continuation of application No. PCT/CN2022/142039, filed on Dec. 26, 2022.

(51) Int. Cl. H04W 72/044; H04L 5/00

(52) U.S. Cl. CPC H04W 72/046; H04L 5/0051

(57) ABSTRACT

A method for beam management in sidelink communication by a UE includes initiating or triggering a first stage of beam management, by the UE. The initiating or triggering the first stage of beam management includes the UE indicating or configuring another UE X number of transmissions of a SL signal, where X is a positive integer.

### CROSS-REFERENCE TO RELATED APPLICATION

This application is a Continuation Application of International Application No. PCT/CN2022/142039 filed on Dec. 26, 2022, which is incorporated herein by reference in its entirety.

### BACKGROUND OF DISCLOSURE

### 1. Field of the Disclosure

The present disclosure relates to the field of communication systems, and more particularly, to a user equipment (UE) and a method for beam management in sidelink communication, which can provide a good communication performance and/or provide high reliability.

### 2. Description of the Related Art

In 3rd generation partnership project (3GPP) Release 16, the sidelink technology has been developed based on the latest 5th generation (5G) new radio (NR) access system including the support of frequency range 1 (FR1) bands (410 MHz-7125 MHz), frequency range 2 (FR2) bands (24250 MHz-71000 MHz) and various OFDM transmission numerologies/sub-carrier spacings (SCSs) (15k Hz, 30k Hz, 60k Hz, and 120k Hz). One of the main motivations to support additional spectrum bands compared to the 4G long term evolution (LTE) system (i.e., frequency range 2, FR2) is the availability of large spectral bandwidth to support high data rate applications and various SCSs to allow very low latency radio transmissions for delay sensitive services. However, main drawbacks of using high frequency bands (i.e., in FR2) for radio transmission are the high attenuation of signal strength over distance from the transmitter (high pathloss) and the system is prone to frequency/phase errors due to the short wavelengths. For the NR sidelink system, it is claimed to support FR2 spectrum bands by introducing a phase tracking reference signal (PT-RS) in Release 16. However, no particular enhancement or feature has been supported in NR sidelink to combat/mitigate the high pathloss issue in FR2.

Therefore, there is a need for a user equipment (UE) and a method for beam management in sidelink communication, which can solve issues in the prior art, provide a beam management for sidelink communication, minimize/reduce sidelink (SL) resource and UE processing overhead without sacrificing the accuracy/correctness of selecting the best receive beam by a receiver UE (Rx-UE), achieve a more resource efficient beam sweeping and selection process, achieve faster beam selection and reporting, provide a good communication performance, and/or provide high reliability.

### SUMMARY

In a first aspect of the present disclosure, a user equipment (UE) includes an executor configured to initiate or trigger a first stage of beam management, where initiating or triggering the first stage of beam management includes the executor indicating or configuring another UE X number of transmissions of a sidelink (SL) signal, where X is a positive integer.

In a second aspect of the present disclosure, a method for beam management in sidelink communication by a user equipment (UE) includes initiating or triggering a first stage of beam management, by the UE, where initiating or triggering the first stage of beam management includes the UE indicating or configuring another UE X number of transmissions of a sidelink (SL) signal, where X is a positive integer.

In a third aspect of the present disclosure, a user equipment (UE) includes a memory, a transceiver, and a processor coupled to the memory and the transceiver. The UE is configured to perform the above method.

In a fourth aspect of the present disclosure, a non-transitory machine-readable storage medium has stored thereon instructions that, when executed by a computer, cause the computer to perform the above method.

In a fifth aspect of the present disclosure, a chip includes a processor, configured to call and run a computer program stored in a memory, to cause a device in which the chip is installed to execute the above method.

In a sixth aspect of the present disclosure, a non-transitory computer readable storage medium, in which a computer program is stored, causes a computer to execute the above method.

In a seventh aspect of the present disclosure, a computer program product includes a computer program, and the computer program causes a computer to execute the above method.

In an eighth aspect of the present disclosure, a computer program causes a computer to execute the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures.

FIG. 1 is a block diagram of user equipments (UEs) of communication in a communication network system according to an embodiment of the present disclosure.

FIG. 2 is a schematic diagram illustrating a user plane protocol stack according to an embodiment of the present disclosure.

FIG. 3 is a schematic diagram illustrating a control plane protocol stack according to an embodiment of the present disclosure.

FIG. 4 is a flowchart illustrating a method for beam management in sidelink communication by a UE according to an embodiment of the present disclosure.

FIG. 5 is a schematic diagram illustrating a proposed receive beam sweeping and management based on broad-sampling according to an embodiment of the present disclosure.

FIG. 6 is a schematic diagram illustrating a proposed receive beam sweeping and management based on sub-sampling according to an embodiment of the present disclosure.

FIG. 7 is a block diagram of a UE for wireless communication according to an embodiment of the present disclosure.

FIG. 8 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. The terminologies in the embodiments of the present disclosure are merely for describing the purpose of the certain embodiment, but not to limit the disclosure.

In the advancement of radio wireless transmission and reception directly between two devices, which is often known as device-to-device (D2D) communication, it was first developed by 3rd generation partnership project (3GPP) and introduced in Release 12 (officially specified as sidelink communication) and improved in Release 13 for Public Safety emergency usage such as mission critical communication to support mainly low data rate and voice type of connection. In 3GPP Release 14, 15 and 16, the sidelink technology was advanced to additionally support vehicle-to-everything (V2X) communication as part of global development of intelligent transportation system (ITS) to boost road safety and advanced/autonomous driving use cases. To further expand the support of sidelink technology to wider applications and devices with limited power supply/battery, the technology was further enhanced in Release 17 in the area of power saving and transceiver link reliability. For Release 18, 3GPP is currently looking to evolve the wireless technology and expand its operation into unlicensed frequency spectrum for larger available bandwidth, faster data transfer rate and easier market adoption of D2D communication using sidelink without requiring any mobile cellular operator's involvement to allocate and configure a part of their expansive precious radio spectrum for data services that do not go throughput their mobile networks.

Since 3GPP Release 16, the sidelink technology has been developed based on the latest 5th generation (5G) new radio (NR) access system including the support of frequency range 1 (FR1) bands (410 MHz-7125 MHz), frequency range 2 (FR2) bands (24250 MHz-71000MH2) and various OFDM transmission numerologies/sub-carrier spacings (SCSs) (15k, 30k, 60k and 120k Hz). One of the main motivations to support additional spectrum bands compared to the 4G long term evolution (LTE) system (i.e., FR2) is the availability of large spectral bandwidth to support high data rate applications and various SCSs to allow very low latency radio transmissions for delay sensitive services. However, main drawbacks of using high frequency bands (i.e., in FR2) for radio transmission are the high attenuation of signal strength over distance from the transmitter (high pathloss) and the system is prone to frequency/phase errors due to the short wavelengths. For the NR sidelink system, it is claimed to support FR2 spectrum bands by introducing a phase tracking reference signal (PT-RS) in Release 16. However, no particular enhancement or feature has been supported in NR sidelink to combat/mitigate the high pathloss issue in FR2.

### Transmit Beamforming and Sweeping in Downlink

Over the downlink (DL) and uplink (UL) of the Uu interface, the concept/feature of transmit beamforming and beam management is developed and introduced since the beginning of the 5G-NR system in Release 15 to improve received signal strength, enhance cellular DL and UL coverages and minimize radio interference to neighbor cells. In order to enable this transmit beamforming/beam management feature over the Uu interface, particularly in the DL, the concept of beam sweeping is introduced by forming a transmit beam and sweeping it across all the directions in space (both horizontal and vertical spatial domains) that the base station (gNB) supports. Once a user equipment (UE) has received all the transmit beams or as many as it could (according to a pre-defined pattern and time interval), the UE selects a best beam and sends a physical random-access channel (PRACH) to the gNB in a RACH occasion that corresponds to the selected best beam. At the base station, gNB determines the selected best beam from the UE according to the received RACH occasion and uses the selected best beam to complete the random-access procedure in order for the UE to connect to the base station. The same best beam may be also used for subsequent data communication between the gNB and the UE until it is further updated/switched.

### Necessity of Transmit Beamforming and Beam Management in Sidelink

As mentioned previously, radio communication in high frequency spectrum (i.e., FR2 bands) may suffer from large attenuation in the transmitted signals and propagation loss through the space compared to the lower frequency bands that the cellular system traditionally operates. Besides the PT-RS that can be used by sidelink communicating devices to correct phase errors in the received carrier frequency in FR2 and the maximum device transmit power is limited by a device's power class definition, there is currently no other way to improve the communication range/signal coverage but to also support transmit beamforming and beam management for the NR sidelink technology. By improving the signal coverage/communication range for sidelink, it enables a few new use cases and applications for the users, such as enhancing the network coverage from SL relaying on a FR2 carrier and offloading network traffic onto a sidelink FR2 carrier for two UEs that are within the same cell.

### Necessity of Receive Beamforming and Beam Management in Sidelink

Besides the transmit beamforming that could be employed at the base station of a 5G system to improve signal coverage of a transmitted signal, if a UE is also equipped with multiple antenna elements for reception, a receive beamforming could be also adopted to further enhance the received signal power (and hence improving the signal coverage and communication reliability) by maximizing the antenna gain/preferentially observed in a certain direction (also common known as spatial filtering) aiming towards the transmitter node.

For sidelink communication in the FR2, the receive beamforming technique/signal processing is particularly beneficial and critical as well to avoid an unbalanced/unequal communication range between a pair of two communication UEs. If one of the communicating UEs (UE_1) already uses transmit beamforming for SL transmission in one direction, regardless of whether or not the other UE (UE_2) uses transmit/receive beamforming for SL, the communication range/coverage may be different between UE_1 transmission and UE_1 reception if receive beamforming is not used for SL reception at UE_1. That is, the communication range may be longer when UE_1 transmits and UE_2 receives than the communication range when UE_2 transmits and UE_1 receives, due different antenna gains for transmission and reception at UE_1. Therefore, there is a need to support receive beamforming in SL communication when a UE is capable of performing transmit beamforming.

### B2B Transmission/Multi-Consecutive Slots Transmission (MCSt)

The main purpose of B2B transmission (which can be also referred as “burst transmission” or “multi-consecutive slot transmission”) is intended for a sidelink (SL) communicating UE to occupy an unlicensed channel continuously for a longer duration of time (i.e., more than one time slot) to mitigate the risk of losing access to the unlicensed channel to a wireless transmission (Tx) device of another radio access technology (RAT). This B2B transmission can be particular important and useful for a SL Tx-UE operating in an unlicensed radio frequency spectrum that has a large size of data transport block (TB) or medium access control (MAC) packet data unit (PDU), requires multiple retransmissions, sidelink hybrid automatic repeat request (SL-HARQ) feedback is disabled, and/or with a short latency requirement (small packet delay budget, PDB). When the unlicensed wireless channel is busy/congested (e.g., with many devices trying to access the channel simultaneously for transmission), it can be difficult and take up a long time to gain access to the channel due to the random backoff timer and priority class category in the LBT procedure. And hence, when a UE finally has a chance/opportunity to gain access to the wireless channel for a channel occupancy time (COT) length which may last for a few milliseconds (e.g., 2 ms, 4 ms, 6 ms, or 10 ms), the intention is to retain the channel access for as long as possible (e.g., all or most of the COT length) to send as much data as possible by continuously transmitting in the unlicensed channel such that wireless devices of other RATs would not have a chance to access the channel.

In some embodiments, for the present proposed receive beam management for sidelink communication (e.g., in FR2 range), receive beams are selectively/strategically swept across different directions and measured by a receiver UE (Rx-UE) based on a beam sampling principle during an initial beam selection, tracking and updating processes to minimize SL resource and UE processing overhead without sacrificing the accuracy/correctness of selecting the best receive beam by the sidelink Rx-UE. Other benefits from using the proposed receive beam sweeping and management methods for SL communication may also include:
reduced sweeping/sampling of receive beams may also provide a faster beam selection process and less SL resources are used. This equivalently means a more resource efficient beam sweeping and selection process can be achieved;
reduced sweeping of receive beams also means less measurement and computation of beams received at the Rx-UE. Then faster selection and reporting is achieved.

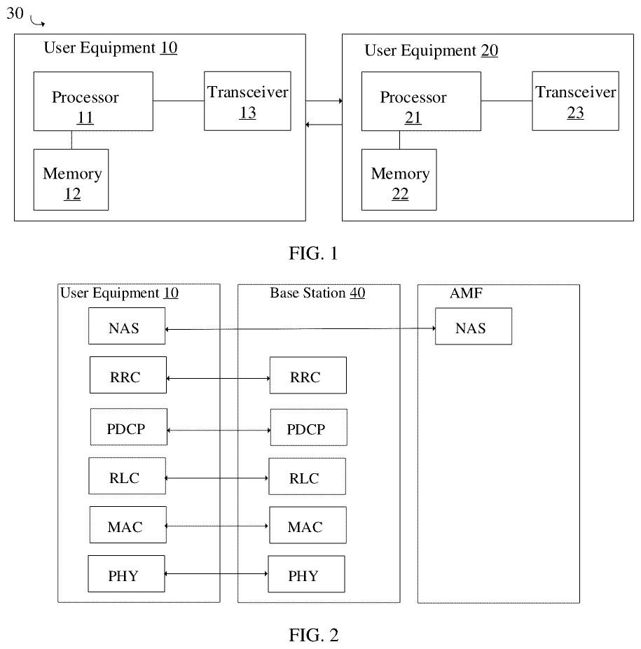

FIG. 1 illustrates that, in some embodiments, one or more user equipments (UEs) 10 (such as a first UE) and one or more user equipments (UEs) 20 (such as a second UE) of communication in a communication network system 30 according to an embodiment of the present disclosure are provided. The communication network system 30 includes one or more UEs 10 and one or more UE 20. The UE 10 may include a memory 12, a transceiver 13, and a processor 11 coupled to the memory 12 and the transceiver 13. The UE 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21 and transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

The communication between UEs relates to vehicle-to-everything (V2X) communication including vehicle-to-vehicle (V2V), vehicle-to-pedestrian (V2P), and vehicle-to-infrastructure/network (V2I/N) according to a sidelink technology developed under 3rd generation partnership project (3GPP) long term evolution (LTE) and new radio (NR) releases 17, 18 and beyond. UEs are communicated with each other directly via a sidelink interface such as a PC5 interface. Some embodiments of the present disclosure relate to sidelink communication technology in 3GPP NR release 17 and beyond, for example providing cellular-vehicle to everything (C-V2X) communication.

In some embodiments, the UE 10 may be a sidelink packet transport block (TB) transmission UE (Tx-UE). The UE 20 may be a sidelink packet TB reception UE (Rx-UE) or a peer UE. The sidelink packet TB Rx-UE can be configured to send ACK/NACK feedback to the packet TB Tx-UE. The peer UE 20 is another UE communicating with the Tx-UE 10 in a same SL unicast or groupcast session.

FIG. 2 illustrates an example user plane protocol stack according to an embodiment of the present disclosure. FIG. 2 illustrates that, in some embodiments, in the user plane protocol stack, where service data adaptation protocol (SDAP), packet data convergence protocol (PDCP), radio link control (RLC), and media access control (MAC) sublayers and physical (PHY) layer (also referred as first layer or layer 1 (L1) layer) may be terminated in a UE 10 and a base station 40 (such as gNB) on a network side. In an example, a PHY layer provides transport services to higher layers (e.g., MAC, RRC). In an example, services and functions of a MAC sublayer may include mapping between logical channels and transport channels, multiplexing/demultiplexing of MAC service data units (SDUs) belonging to one or different logical channels into/from transport blocks (TBs) delivered to/from the PHY layer, scheduling information reporting, error correction through hybrid automatic repeat request (HARQ) (e.g. one HARQ entity per carrier in case of carrier aggregation (CA)), priority handling between UEs by means of dynamic scheduling, priority handling between logical channels of one UE by means of logical channel prioritization, and/or padding. A MAC entity may support one or multiple numerologies and/or transmission timings. In an example, mapping restrictions in a logical channel prioritization may control which numerology and/or transmission timing a logical channel may use. In an example, an RLC sublayer may supports transparent mode (TM), unacknowledged mode (UM) and acknowledged mode (AM) transmission modes. The RLC configuration may be per logical channel with no dependency on numerologies and/or transmission time interval (TTI) durations. In an example, automatic repeat request (ARQ) may operate on any of the numerologies and/or TTI durations the logical channel is configured with. In an example, services and functions of the PDCP layer for the user plane may include sequence numbering, header compression, and decompression, transfer of user data, reordering and duplicate detection, PDCP PDU routing (e.g., in case of split bearers), retransmission of PDCP SDUs, ciphering, deciphering and integrity protection, PDCP SDU discard, PDCP re-establishment and data recovery for RLC AM, and/or duplication of PDCP PDUs. In an example, services and functions of SDAP may include mapping between a QoS flow and a data radio bearer. In an example, services and functions of SDAP may include mapping quality of service Indicator (QFI) in downlink (DL) and uplink (UL) packets. In an example, a protocol entity of SDAP may be configured for an individual PDU session.

In the embodiments, a method for beam management in sidelink communication by a user equipment (UE) is provided, which includes:
initiating or triggering a first stage of beam management, by the UE, where initiating or triggering the first stage of beam management includes the UE indicating or configuring another UE X number of transmissions of a sidelink (SL) signal, where X is a positive integer.

In some embodiments, the method further includes that the UE determines a set of one or more preferred receive beams for receiving the X number of transmissions of the SL signal from the another UE.

In some embodiments, for each one of the X number of transmissions of the SL signal, the UE is configured to use a different receive beam for SL reception and perform a radio measurement on the SL signal for selecting one or more top K preferred beams, where K is a positive integer.

In some embodiments, K is configured or pre-defined from a range between 1 and up to 4.

In some embodiments, a set of receive beams used by the UE for reception and measurement of the X number of transmissions of the SL signal includes a set of broad-beams or a sub-set of all receive beams.

In some embodiments, initiating or triggering the first stage of beam management is performed periodically for selection of at least one initial receive beam and/or a beam tracking/updating, or event triggered based on a beam failure reporting/consistent beam failure indication, a change in the measurement from using one or more receive beams, and/or radio link failure detection/indication.

In some embodiments, the method further includes initiating or triggering a second stage of beam management, by the UE, where initiating or triggering the second stage of beam management includes the UE indicating or configuring the another UE Y number of transmissions of the SL signal, where Y is a positive integer.

In some embodiments, the method further includes that the UE determines a set of one or more best receive beams for receiving the Y number of transmissions of the SL signal from the another UE.

In some embodiments, for each one of the Y number of transmissions of the SL signal, the UE is configured to use a different receive beam for SL reception and perform a radio measurement on the SL signal for selecting one or more top L best beams, where L is a positive integer.

In some embodiments, L is configured or pre-defined from a range between 1 and up to 4.

In some embodiments, the UE is configured to initiate or trigger the second stage of beam management according to one or more of the following conditions/triggers:
as part of an initial selection of one or more best receive beams for SL communication between at least two UEs, where the second stage of beam management has not previously been performed by the UE;
when there is a change in selected one or more top K preferred beams from a past in the first stage of beam management during a beam tracking/updating; and
when the UE observes a change in a measurement of one or more selected/currently used best beams from a last/most recently performed second stage of beam management.

In some embodiments, the second stage of beam management is initiated or triggered after the first stage of beam management as part of an initial selection of best beams or when there is a change in the measurements in the first stage of beam management.

In some embodiments, the second stage of beam management is initiated or triggered independently from the first stage of beam management or the second stage of beam management is initiated or triggered without having firstly performed the first stage of beam management when there is a change in a measurement during a beam tracking/updating.

In some embodiments, the X and/or Y number of transmissions of the SL signal is based on a multi-consecutive slots transmission (MCSt).

In some embodiments, the method further includes that the UE indicates or configures the another UE a transmit beam index or an identifier (ID) for transmitting the SL signal the X and/or Y number of times.

In some embodiments, the UE indicating or configuring the another UE the X and/or Y number of transmissions of the SL signal includes that the UE indicates or configures the another UE a time and frequency resource, and/or a transmission periodicity for the X and/or Y number of transmissions of the SL signal.

In some embodiments, the UE is configured to indicate or configure the another UE the X and/or Y number of transmissions of the SL signal using a PC5 radio resource control (RRC) signaling, a PC5 sidelink control information (SCI) signaling, a physical sidelink feedback channel (PSFCH), and/or a PC5 medium access control (MAC) control element (CE) signaling.

In some embodiments, the X and/or Y number of transmissions of the SL signal includes at least one of the followings: a channel state information-reference signal (CSI-RS), a demodulation reference signal (DM-RS), or a sidelink-synchronization signal block (S-SSB).

In some embodiments, the one or more preferred beams and/or the one or more best beams are determined based on at least one of the followings: a received power of sidelink channel state information-reference signal (SL CSI-RSRP), a sidelink received signal strength indicator (RSSI), an estimation of 10% block error rate (BLER) of physical sidelink control channel (PSCCH), a sidelink carrier-to-interference ratio (C/I), or a sidelink signal-to-interference noise ratio (SINR).

In some embodiments, the set of broad-beams in the first stage of beam management and receive beams in the second stage of beam management are in different frequency carriers or in a same frequency carrier.

In some embodiments, a beam pattern and/or a periodicity of the set of broad-beams in the first stage of beam management are configured or pre-defined.

In some embodiments, a receive beam pattern of the sub-set of all receive beams including a periodicity and a sub-sampling gap between the sub-set of all receive beams are configured or pre-defined.

In some embodiments, the receive beam pattern of the sub-set of all receive beams are every second, every third, or every fourth receive beams.

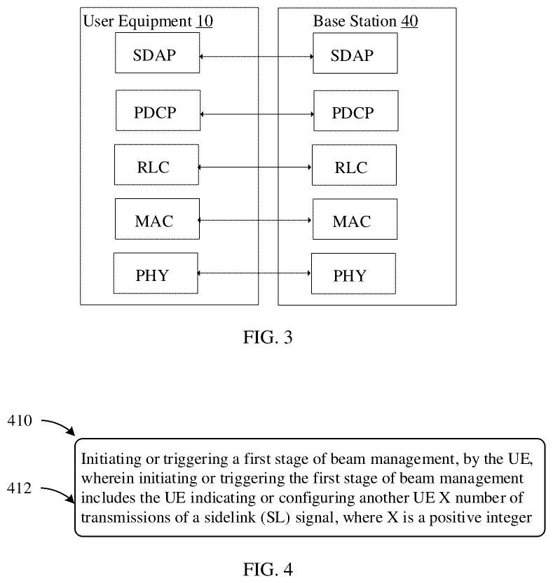

FIG. 3 illustrates an example control plane protocol stack according to an embodiment of the present disclosure. FIG. 2 illustrates that, in some embodiments, in the control plane protocol stack where PDCP, RLC, and MAC sublayers and PHY layer may be terminated in a UE 10 and a base station 40 (such as gNB) on a network side and perform service and functions described above. In an example, RRC used to control a radio resource between the UE and a base station (such as a gNB). In an example, RRC may be terminated in a UE and the gNB on a network side. In an example, services and functions of RRC may include broadcast of system information related to AS and NAS, paging initiated by 5GC or RAN, establishment, maintenance and release of an RRC connection between the UE and RAN, security functions including key management, establishment, configuration, maintenance and release of signaling radio bearers (SRBs) and data radio bearers (DRBs), mobility functions, QoS management functions, UE measurement reporting and control of the reporting, detection of and recovery from radio link failure, and/or non-access stratum (NAS) message transfer to/from NAS from/to a UE. In an example, NAS control protocol may be terminated in the UE and AMF on a network side and may perform functions such as authentication, mobility management between a UE and an AMF for 3GPP access and non-3GPP access, and session management between a UE and a SMF for 3GPP access and non-3GPP access.

When a specific application is executed and a data communication service is required by the specific application in the UE, an application layer taking charge of executing the specific application provides the application-related information, that is, the application group/category/priority information/ID to the NAS layer. In this case, the application-related information may be pre-configured/defined in the UE. (Alternatively, the application-related information is received from the network to be provided from the AS (RRC) layer to the application layer, and when the application layer starts the data communication service, the application layer requests the information provision to the AS (RRC) layer to receive the information.)

In some embodiments, the processor 11 is configured to initiate or trigger a first stage of beam management, where initiating or triggering the first stage of beam management includes the processor 11 indicating or configuring another UE 20 X number of transmissions of a sidelink (SL) signal, where X is a positive integer. This can solve issues in the prior art, provide a beam management for sidelink communication, minimize/reduce sidelink (SL) resource and UE processing overhead without sacrificing the accuracy/correctness of selecting the best receive beam by a receiver UE (Rx-UE), achieve a more resource efficient beam sweeping and selection process, achieve faster beam selection and reporting, provide a good communication performance, and/or provide high reliability.

FIG. 4 illustrates a method 410 for beam management in sidelink communication by a UE according to an embodiment of the present disclosure. In some embodiments, the method 410 includes: a block 412, initiating or triggering a first stage of beam management, by the UE, where initiating or triggering the first stage of beam management includes the UE indicating or configuring another UE X number of transmissions of a sidelink (SL) signal, where X is a positive integer. This can solve issues in the prior art, provide a beam management for sidelink communication, minimize/reduce sidelink (SL) resource and UE processing overhead without sacrificing the accuracy/correctness of selecting the best receive beam by a receiver UE (Rx-UE), achieve a more resource efficient beam sweeping and selection process, achieve faster beam selection and reporting, provide a good communication performance, and/or provide high reliability.

In some embodiments, the method further includes the UE determining a set of one or more preferred receive beams for receiving the X number of transmissions of the SL signal from the another UE. In some embodiments, for each one of the X number of transmissions of the SL signal, the UE is configured to use a different receive beam for SL reception and perform a radio measurement on the SL signal for selecting one or more top K preferred beams, where K is a positive integer. In some embodiments, K is configured or pre-defined from a range between 1 and up to 4. In some embodiments, a set of receive beams used by the UE for reception and measurement of the X number of transmissions of the SL signal includes a set of broad-beams or a sub-set of all receive beams.

In some embodiments, initiating or triggering the first stage of beam management is performed periodically for selection of at least one initial receive beam and/or a beam tracking/updating, or event triggered based on a beam failure reporting/consistent beam failure indication, a change in the measurement from using one or more receive beams, and/or radio link failure detection/indication. In some embodiments, the method further includes initiating or triggering a second stage of beam management, by the UE, where initiating or triggering the second stage of beam management includes the UE indicating or configuring the another UE Y number of transmissions of the SL signal, where Y is a positive integer. In some embodiments, the method further includes the UE determining a set of one or more best receive beams for receiving the Y number of transmissions of the SL signal from the another UE.

In some embodiments, for each one of the Y number of transmissions of the SL signal, the UE is configured to use a different receive beam for SL reception and perform a radio measurement on the SL signal for selecting one or more top L best beams, where L is a positive integer. In some embodiments, L is configured or pre-defined from a range between 1 and up to 4. In some embodiments, the UE is configured to initiate or trigger the second stage of beam management according to one or more of the following conditions/triggers: as part of an initial selection of one or more best receive beams for SL communication between at least two UEs, where the second stage of beam management has not previously been performed by the UE; when there is a change in selected one or more top K preferred beams from a past in the first stage of beam management during a beam tracking/updating; and when the UE observes a change in a measurement of one or more selected/currently used best beams from a last/most recently performed second stage of beam management.

In some embodiments, the second stage of beam management is initiated or triggered after the first stage of beam management as part of an initial selection of best beams or when there is a change in the measurements in the first stage of beam management. In some embodiments, the second stage of beam management is initiated or triggered independently from the first stage of beam management or the second stage of beam management is initiated or triggered without having firstly performed the first stage of beam management when there is a change in a measurement during a beam tracking/updating. In some embodiments, the X and/or Y number of transmissions of the SL signal is based on a multi-consecutive slots transmission (MCSt). In some embodiments, the method further includes the UE indicating or configuring the another UE a transmit beam index or an identifier (ID) for transmitting the SL signal the X and/or Y number of times.

In some embodiments, the UE indicating or configuring the another UE the X and/or Y number of transmissions of the SL signal includes the UE indicating or configuring the another UE a time and frequency resource, and/or a transmission periodicity for the X and/or Y number of transmissions of the SL signal. In some embodiments, the UE is configured to indicate or configure the another UE the X and/or Y number of transmissions of the SL signal using a PC5 radio resource control (RRC) signaling, a PC5 sidelink control information (SCI) signaling, a physical sidelink feedback channel (PSFCH), and/or a PC5 medium access control (MAC) control element (CE) signaling. In some embodiments, the X and/or Y number of transmissions of the SL signal includes at least one of the followings: a channel state information-reference signal (CSI-RS), a demodulation reference signal (DM-RS), or a sidelink-synchronization signal block (S-SSB). In some embodiments, the one or more preferred beams and/or the one or more best beams are determined based on at least one of the followings: a received power of sidelink channel state information-reference signal (SL CSI-RSRP), a sidelink received signal strength indicator (RSSI), an estimation of 10% block error rate (BLER) of physical sidelink control channel (PSCCH), a sidelink carrier-to-interference ratio (C/I), or a sidelink signal-to-interference noise ratio (SINR).

In some embodiments, the set of broad-beams in the first stage of beam management and receive beams in the second stage of beam management are in different frequency carriers or in a same frequency carrier. In some embodiments, a beam pattern and/or a periodicity of the set of broad-beams in the first stage of beam management are configured or pre-defined. In some embodiments, a receive beam pattern of the sub-set of all receive beams including a periodicity and a sub-sampling gap between the sub-set of all receive beams are configured or pre-defined. In some embodiments, the receive beam pattern of the sub-set of all receive beams are every second, every third, or every fourth receive beams.

In the above embodiments, the term “configured” can refer to “pre-configured” and “network configured”. The term “pre-defined” or “pre-defined rules” in the present disclosure may be achieved by pre-storing corresponding codes, tables, or other manners for indicating relevant information in devices (e.g., including a UE and a network device). The specific implementation is not limited in the present disclosure. For example, “pre-defined” may refer to those defined in a protocol. It is also to be understood that in the disclosure, “protocol” may refer to a standard protocol in the field of communication, which may include, for example, an LTE protocol, NR protocol and relevant protocol applied in the future communication system, which is not limited in the present disclosure.

### Examples

In some embodiments, for the present disclosure of a new inventive management scheme for receive beams in sidelink (SL) communication, mainly targeting SL unicast and SL groupcast communications, the SL beam management strategy is based on a two-stage scheme with different scale of receive beams to minimize the resources and processing efforts needed to determine a set of best beams for the SL communication. To determine the two different scales of transmit beams, there can be two different beam sampling methods as well.

According to the existing design of beam sweeping mechanism adopted in the downlink (DL) of 5G-NR system, as mentioned earlier, transmit beams from the base station gNB are swept across all directions and a UE selects a best beam and transmits a random-access preamble in a random-access channel (RACH) occasion that corresponds to the selected best beam. Over the Uu interface in the downlink, a such blind sweep of transmit beams in all directions is necessary to support UEs in the cell that are in a RRC IDLE state and to extend the cell coverage as wide as possible (so that UEs from far can still receive cell system information and connect to the base station gNB). Although a such blind sweep of transmit beams is necessary for the downlink, but it still take up a lot of radio resources to repeatedly transmit synchronization signal block (SSB) in all directions (i.e., up to 64 beams or more). Furthermore, the beam sweeping operation needs to periodically perform over time so that new system information can be conveyed to all UEs in the cell and all new incoming/camping UEs are able to connect to the base station. As such, it is rather seen as a very resource inefficient beam sweeping and management operation. Overall, a such operation may be acceptable since all UEs are connecting/communicating with a same central node, gNB. Therefore, only the central node (gNB) needs to perform the beam sweeping operation.

On the other hand, for wireless radio reception in a device user equipment (UE), there can be just as many receive beams as there are transmit beams. As previously explained, finding a right receive beam targeting towards a direction where the signal is coming from (e.g., angle of arrival to the UE's antenna array) can greatly improve the received signal power of the data packet transmitted from an intended transmitter UE (Tx-UE). At the same time, it can reduce interference by suppressing received signals from unwanted directions at the receiver UE (Rx-UE).

In some existing receive beam management schemes used in cellular communication or other radio access technologies, a same signal/data is repeated several times by a transmitter node for the purpose of training an intended receiver to find a best receive beam by trying different receive beams aiming at different directions. This could be a very expansive exercise in terms of radio resource usage by transmitting the same data signal repeatedly in a same direction when a Rx-UE is equipped with many antenna elements supporting a large number of receive beams. In addition, the amount of battery power consumed at the Tx-UE just for receive beam management and training at another UE. Moreover, the UE processing power and computation measurements required at the Rx-UE and the prolonged latency/delay caused in the actual data communication due to receive the receive beam management and training.

Furthermore, the main primary communication mechanism employed in the cellular DL is unicast type of transmission, relying on hybrid automatic repeat request-acknowledge (HARQ-ACK) feedbacks from the Rx-UE. After each DL transmission of a data transport block (TB), a HARQ-ACK report is to be provided by the Rx-UE before base station sensing a retransmission of the same TB. If an ACK is received, no retransmission is performed since the data TB has already been successfully decoded and the buffer is cleared at the Rx-UE. In this case, the gNB has to send dummy data in the DL in order for the Rx-UE to complete the Rx beam sweeping/training, for which is a very resource inefficient mechanism. Therefore, a different beam management and beam sweeping strategy is needed to avoid the above-described problems.

### Proposed Receive Beam Management and Sweeping Mechanism

In order to minimize the necessity and the amount of sweeping and management of receive beams at a Rx-UE in sidelink communication, which may subsequently reduce the amount of SL resources and Rx-UE processing time/computation effort, it is proposed to adopt a two-stage beam management concept scheme with a “sampling” principle in receive beam sweeping.

For the overall beam management in sidelink communication, which includes different processes of initial receive beam sweeping and measurement at a Rx-UE, selection of best receive beam(s), tracking plus updating of best beam(s), and beam failure recovery, these different processes can be all supported by the proposed two stage concept scheme.

The 1st stage of beam management in sidelink communication is a so call “large-scale” sampling of Rx-UE's receive beams in widespread of directions. For this stage of the beam management and sweeping, the intention is to detect/find out a general direction in which the Rx-UE can steer a receive beam towards that may either maximize the received power of a transmitted SL signal from a Tx-UE, minimize a decoding block error rate (BLER) of physical sidelink control channel (PSCCH), and/or minimize a received interference. As such, a good performance of SL communication between the Tx-UE and the Rx-UE can be achieved. In an initial selection of one or more receive beams between two SL communicating UEs (a Tx-UE and a Rx-UE), the 1st stage is used as an intermediate step towards a full receive beam management for the Rx-UE. Once a general direction of receive beam is detected in the 1st stage of beam management, the Rx-UE performs a 2nd stage to identified and select a finer/pencil-like direction for a best receive beam to further enhance the receive power, lower the decoding error rate and/or reduce the interference, and thus, to maximize the SL communication performance for the UEs.

In addition to and after the initial selection of one or more best receive beams between the two SL UEs, the 1st stage of beam management and sweeping can be also used for tracking and updating the selected best receive beam(s). If the general direction of the receive beam at the Rx-UE has changed during a beam tracking from performing the 1st stage of beam management, the Rx-UE performs the 2nd stage of beam management to identify and select one or more new best receive finer beams for the continuing SL communication. If the general direction of the receive beam at the Rx-UE has NOT changed during the beam tracking, then there is no need to perform the 2nd stage of beam management and sweeping for a new best receive beam.

More particularly, during the 1st stage of beam management and sweeping, only a set of broad-beams for reception (Exemplary Method 1) or a subset of all supported receive beams (Method 2) are used by the Rx-UE to detect one or more general directions according to the two proposed beam sampling methods. The general concept of the 1st stage of beam management is for a Rx-UE to receive and sweep across a number of general directions with minimum number of beams for both an initial and on-going assessments of receive beams in widespread of directions.

To initiate/trigger the 1st stage of beam management and sweeping of receive beams to find the one or more general directions for the Rx-UE to receive transmission from the Tx-UE, the Rx-UE indicates or configures the Tx-UE a X number of transmissions from the Tx-UE. If the Tx-UE supports a transmit beamforming/beam management, the Rx-UE may additionally indicate/configure the Tx-UE a direction towards which the X number of transmissions can transmit. The indication/configuration of the direction could be a transmit beam index or ID. Furthermore, the indication/configuration could also include the time and frequency resources, and the transmission periodicity for the X number of transmissions in the 1st stage of beam management and sweeping for periodic tracking and evaluation of the selected one or more general directions.

For each one of the X number of transmissions, the Rx-UE uses a different large-scale beam for receiving the transmission from the Tx-UE and performs a radio measurement on a SL signal. That is, the Rx-UE sweeps across X number of large-scale sampled beams and performs a radio measurement on each one of them to determine and select one or more top K preferred beams in the 1st stage of beam management, where K can be (pre-)configured or pre-defined from a range between 1 and up to 4. If the measured channel condition is good and remains relatively static during the beam tracking, the X number of transmissions from the Tx-UE and the selection of large-scale sampled receive beams at the Rx-UE for the 1st stage could be even reduced to save resources and Tx power, minimize latency and reduce computation processing. In the 1st stage, since the large-scale sampled beams are swept in widespread of directions and covered a wide area, it can be used for the initial assessment of receive beams in all directions and also for on-going assessment (tracking) of one or more general directions. As such, this receive beam management and sweeping operation is ideal for SL unicast communication and SL groupcast communication when the number of group member UEs is known (connection-oriented groupcast).

As described earlier in some embodiments, the 1st stage of sweeping across a large-scale sampling of receive beams is used by a Rx-UE for an initial selection of one or more best receive beams for SL communication between two SL UEs and on-going assessment (beam tracking) of a selected general direction for receiving SL data transmission from the Tx-UE, the 1st stage may be operated in the following manners.
1. The 1st stage of sweeping of receive beams in widespread of directions could be periodically performed for the purposes of: Selection of initial receive beam(s) for SL groupcast and unicast communications (e.g., before connection setup) and beam tracking and updating during SL groupcast and unicast communications. Further reduction in number of large-scale samplings is possible during the SL groupcast and unicast communications. Since the location/position of SL communicating UEs may be fixed (non-moveable), it is sufficient to limit the number of receive beams from the initial selection to just one or may be including the immediate adjacent ones to account for some movement of position.
2. Event triggered based on beam failure reporting/consistent beam failure for the purpose of beam failure recovery (e.g., in SL groupcast and unicast communications), based on changes in the measurement of one or more existing best receive beams, or based on radio link failure detection/indication.

The 2nd stage of beam management in sidelink communication is a so call “small-scale” sampling of Rx-UE's receive beams that are confined within, associated with, close/adjacent to, or in-between the one or more K preferred beams determined/selected during the 1st stage of beam management. For this stage of the beam management, one or more “pencil like” fine-beams that are confined within, associated with, close/adjacent to, or in-between the one or more K preferred beams are swept across by the Rx-UE according to the two proposed beam sampling methods (Exemplary Method 1 and Method 2) for the purpose of fine tuning a more precise receive beam for SL communication in a direction that may provide the most performance gain in term of received power, signal coverage, minimum interference, and/or highest decoding reliability at the Rx-UE.

To trigger/initiate the 2nd stage of beam management and sweeping of receive beams to find the one or more fine beams (directions) to be used by the Rx-UE that are best for receiving SL transmissions from the Tx-UE, the Rx-UE provides a request/indication to the Tx-UE using a physical sidelink feedback channel (PSFCH), a PC5 RRC, SCI, or MAC CE signaling a Y number of transmissions from the Tx-UE for fine tuning/determining one or more best receive/fine beams. If the Tx-UE supports a transmit beamforming/beam management, the Rx-UE may additionally indicate/configure the Tx-UE a direction towards which the Y number of transmissions can transmit.

The indication/configuration of the direction could be a transmit beam index or ID. Furthermore, the indication/configuration could also include time and frequency resources, and transmission periodicity for the Y number of transmissions in the 2nd stage of beam management and sweeping for periodic tracking and evaluation of the determined one or more fine/best directions.

For each one of the Y number of transmissions from the Tx-UE, the Rx-UE uses a different small-scale fine beam for receiving the transmission from the Tx-UE and performs a radio measurement on a SL signal. That is, the Rx-UE sweeps across Y number of small-scale sampled beams and performs a radio measurement on each one of them to determine and select a set of L best beams, where L can be (pre-)configured or pre-defined from a range between 1 and up to 4.

The 2nd stage of small-scale sampling of receive beams in fine directions may not need to be performed every time after the 1st stage of large-scale sampling of receive beams in widespread of directions. As mentioned earlier, the location/position of SL communicating UEs may be fixed, fixed relative to each other, or moving very slowly. In these cases, the likelihood of updating/selecting or a need to determine a new best fine beam is quite small. On the other hand, there could be also scenarios where the UEs have moved but not significant causing the large-scale/general beam direction to change. In this case, the best fine beam may need to be re-selected in the general direction. Therefore, it can be possible for the Rx-UE to independently perform the 2nd stage of small-scale sampling of receive beams in fine directions without having firstly performed the 1st stage. As such, the need to for an Rx-UE to perform a 2nd stage of small-scale sampling of fine beams may be limited to one or more of the following scenarios/triggers.
1. As part of an initial selection of one or more best receive (fine) beams for SL communication between at least two UEs, where the 2nd stage of small-scale sampling of fine-beams has not previously been performed by a Rx-UE.
2. When there is a change in the selected one or more top K preferred beams from the past in the 1st stage of beam management and sweeping during a beam tracking. This signifies there is a change in the communication environment in either the Tx-UE and/or the Rx-UE's locations, or something is blocking the existing beam.
3. When Rx-UE observed a change in the measurement of one or more selected/currently used best fine beams from the last/most recently performed 2nd stage receive beam management and sweeping. For example, due to a slow movement of either the Tx-UE or the Rx-UE, the measurement of the existing/on-going selected best beam(s) is beginning to deteriorate. As such, the existing/on-going selected beam(s) used for SL communication may not be the best beam(s) any longer. As long as the selected preferred beam(s) has not changed in the 1st stage of beam management, a small update/switch of the best fine-beam(s) may be necessary.

The X number of transmissions in the 1st stage and the Y number of transmissions in the 2nd stage of beam management and sweeping from the Tx-UE could be based on a multi-consecutive slots transmission (MCSt) in SL communication to enable rapid transmissions of a SL signal in the same direction to mitigate any risk in fast changing of channel conditions in order to achieve an accurate and fair measurement comparison from using the different receive beams. Additionally, by utilizing MCSt for (re)transmissions of a same data TB, which does not require a SL hybrid automatic repeat request (HARQ) feedback, it provides opportunities for training and tracking of receive beams at the Rx-UE to achieve resource efficiency and minimize resource wastage without needing to blindly repeat the same data TB transmission many times or to transmit dummy data.

The transmitted SL signal from the Tx-UE for both the 1st stage and the 2nd stage of beam management and sweeping could be one of the followings: Channel state information-reference signal (CSI-RS), demodulation reference signal (DM-RS), or sidelink-synchronization signal block (S-SSB).

The radio measurement to be used by the Rx-UE for the selection of both the top K preferred beams in the 1st stage of large-scale sampling or the L best beams in the 2nd stage of small-scale sampling could be based on one or more of the followings. 1. Received power of CSI-RS for sidelink: SL CSI-RSRP. 2. Sidelink received signal strength indicator (RSSI). 3. Estimation of 10% BLER of PSCCH. 4. Sidelink carrier-to-interference ratio (C/I). 5. Sidelink signal-to-interference noise ratio (SINR).

### Exemplary Method 1: Broad-Sampling of Transmit Beams

In Exemplary Method 1 of broad-sampling of transmit beams, the Rx-UE applies and measures a set of broad-beams that would largely cover all the receive beams that are supported by the Rx-UE. Each one of these broad-beams represents a set of “fine” beams and covers a broad range of directions of these fine-beams in the reception. The general idea is to apply and measure a set of broad-sampling of beams to cover a wide range of directions for beam sweeping during the 1st stage of beam management for an initial selection of one or more broad-beams by the Rx-UE. Once the initial selection of the one or more broad-beams (top K preferred beams in the 1st stage of large-scale beam management) is performed by the Rx-UE, the proposed Exemplary Method 1 in the 2nd stage of the proposed beam management the Rx-UE then sweep across the fine-beams that were covered by or associated with the selected one or more broad-beams. By doing so, it can significantly reduce the number of receive beams that a Rx-UE needs to perform beam sweeping (and the number of SL transmissions that a Tx-UE needs to perform in a same direction) for the purpose of a Rx-UE selecting a final/best beam for their SL communication. This type of operation of the 1st stage and 2nd stage of beam management is ideally suited for SL unicast communication and SL groupcast communication with a known number of UEs within the groupcast (e.g., connection-oriented groupcast).

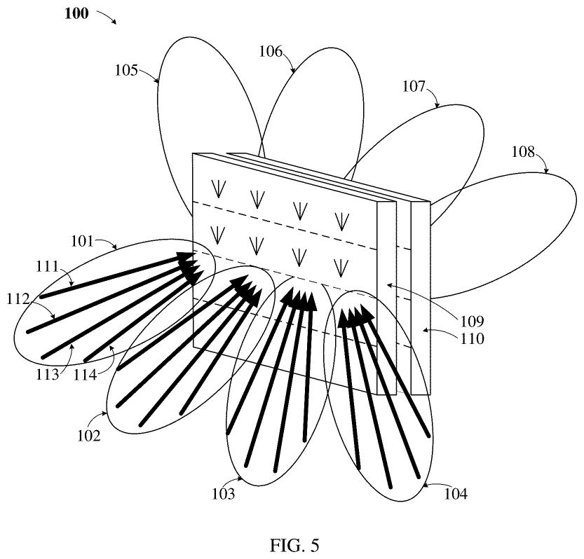

In reference to diagram 100 in FIG. 5, it is assumed a SL Rx-UE device supports two antenna/beam panels and each panel has 16 antenna elements, which can produce/generate receive beams in 16 “fine/pencil-like” directions per panel. Therefore, there can be up to 32 fine-beams supported/generated by the Rx-UE. Instead of performing a beam sweeping and measurement across the all 32 fine-beams at an Rx-UE to select a best beam, it is proposed according to the disclosed Exemplary Method 1 to perform reception of transmitted SL signal from a Tx-UE using a set of broad-beams that would generally cover all directions of the fine-beams. As illustrated in diagram 100, there are in total 8 broad-beams (101-108) that are supported by the Rx-UE covering all directions from the both antenna/beam panels (109 and 110). By receiving and sweeping across these broad-beams, the Rx-UE measures and selects one or more preferred beams. In this case, the Rx-UE selects only broad-beam 101 based on measurement outcome. Subsequently, the Rx-UE initiates/triggers a 2nd stage of receive beam sweeping and measurement of SL signal transmitted by the Tx-UE only for the fine-beams (111-114) that are covered by the broad-beam 101. Then based on the measurement outcome, the Rx-UE performs a final selection of a best beam among the fine-beams 111-114 for SL communication between the two UEs. In the end, the total number of beams that had been used/swept by the Rx-UE to reach a final selection of one best receive beam is 8 broad-sampling beams+4 fine-beams=12 total beams. Compare the proposed Exemplary Method 1 to the existing traditional full sweeps of beams, there is a reduction in the sweeping of 20 transmit beams, which is around 67% saving in number of required resources, UE computation processing and time delay.

For the proposed Exemplary Method 1 of broad-sampling of transmit beams, there is no restriction or requirement that the broad-beams and the fine-beams in the 2nd stage of beam management shall be in a same carrier or in a same frequency range. That is, it is possible for the Rx-UE to perform the 1st stage of broad-sampling of transmit beams using a frequency carrier in FR1, and the 2nd stage of small-scale sweeping of fine-beams using a frequency carrier in FR2. Therefore, it is further proposed for Exemplary Method 1 that the broad-beams in the 1st stage of beam management and the fine-beams in the 2nd stage of beam management process can be in different frequency carriers or in a same frequency carrier.

The beam pattern for the broad-beams in the proposed Exemplary Method 1 can be (pre-)configured or pre-defined in advanced. Depending on UE implementation, different Rx-UE may have different number of antenna panels, arrangement of antenna panels (e.g., 180-degree, 90-degree offset), number of antenna elements per panel, etc. All these can affect the total number of receive beams and the beam directions that are supported by a Rx-UE. For example, a smartphone UE may implement 2 beam panels with 180-degree offset (back-to-back) and supports a total of 32 beams (16 beams per panel). In this case, the UE may be (pre-)configured or pre-defined to have a total of 8 broad-beams with 4 fine-beams per broad-beam. In another example, a vehicle UE may install 4 beam panels with 90-degree offset (one panel installed at the front bumper bar, one panel for the back bumper bar and two panels for the two sides). In this case, only 4 broad-beams can be sufficient to communicate with surrounding vehicles. Therefore, it is proposed for Exemplary Method 1 that a set of broad-beam patterns (e.g., number of broad-beams, number of fine-beams per broad-beam) and the periodicity (how frequent the 1st stage of beam management and sweeping) can be (pre-)configured or pre-defined.

### Method 2: Sub-Sampling of Transmit Beams

In Method 2 of sub-sampling of receive beams, for the 1st stage of large-scale sampling, the Rx-UE uses and measures a sub-set of all supported receive beams sweeping across widespread of directions to detect one or more general directions that may provide better performance for SL communication between at least two UEs compared to no beamforming is used.

The beam pattern for the sub-set of all supported receive beams (hereafter referred as “sub-set of beams”) used in the 1st stage of beam management for large-scale sampling can ideally cover a widespread of directions such that a Rx-UE has a full range of beam directions to perform the reception measurement and selection of top K preferred beams. Different to Exemplary Method 1, where broad-beams that cover all the receive beams are used/measured instead of the fine-beams, in Exemplary Method 2, a sub-set of the actual receive fine-beams supported by the Rx-UE are used and measured. For example, the receive beam pattern for the sub-set of beams could be every second (gap=2), every third (gap=3) or every fourth (gap=4) receive beams. Since the usage/measurement of the sub-set of beams is in principle the same concept as channel probing, as it is well understood that if more samples are taken (with a smaller gap between the samples), the better the estimation and the measurement of the channel can be. However, this is also at an expense of requiring more resource usage, higher UE processing and computation demand, and longer delay in transmitting/measuring all the samples. Hence, firstly, the receive beam pattern including the periodicity (how frequent the sub-sampling of beams can be measured) and the sub-sampling gap between the sub-set of beams can be (pre-)configured or pre-defined.

As described earlier the processes for the proposed 1st stage and 2nd stage of beam management and sweeping of UE receive beams to enhance SL communication performance, the 2nd stage may be triggered after the 1st stage as part of an initial selection of best beams or when there is a change in the measurements in the 1st stage. Or the 2nd stage may be triggered independently (without having firstly performed the 1st stage) when there is a change in the measurements during a beam tracking process. For the 2nd stage of beam management using the proposed Exemplary Method 2, similar to the 1st stage, the Rx-UE also uses/sweeps across a sub-set of all supported receive beams, but this time the beam sweeping is confined within direction boundaries associated to the top K preferred beams selected from the 1st stage of large-scale sampling to fine one or more best fine beams for further enhancing the SL communication performance.

Once the Rx-UE requests/triggers the Tx-UE to perform SL transmission in the same direction for Y number of times, the Rx-UE uses/sweeps across all of the receive beams/fine-beams that are in-between and including the top K preferred beams (just in case the channel condition has changed since the 1st stage of beam management) for the reception and measurement of the Y number of SL transmissions from the Tx-UE. Then based on the measurement results, the Rx-UE performs a final selection or update of best L beams for the SL communication. Similar to the proposed Exemplary Method 1, this type of operation of receiving a sub-set of sampled beams in the 1st stage of beam management and receiving a sub-set of fine-beams based on a set of preferred beams in the 2nd stage of beam management is ideally suited for SL unicast communication and SL groupcast communication with a known number of UEs within the groupcast (e.g., connection-oriented groupcast).

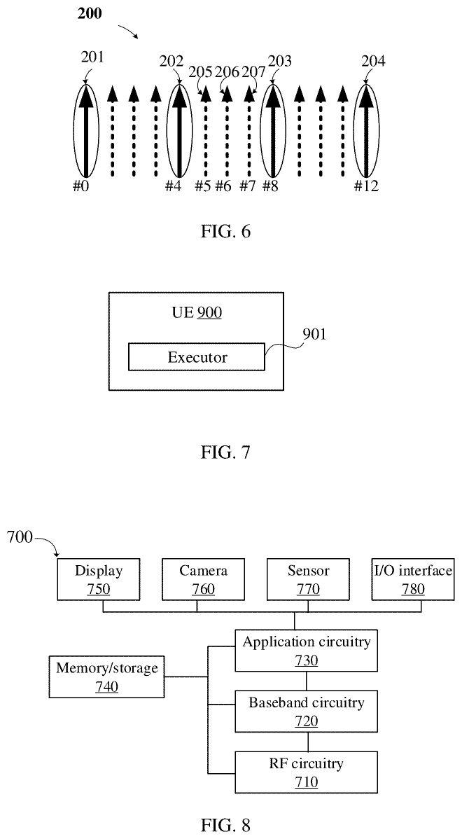

In reference to diagram 200 in FIG. 6, it is assumed a SL Rx-UE device supports and it is capable of generating a total of 13 receive “fine” beams. Instead of performing a beam sweeping across the all 13 fine-beams for an Rx-UE to select a best beam, it is proposed according to the disclosed Exemplary Method 2 to perform SL reception using a sub-set of beams that would generally cover a widespread of directions as the all 13 fine-beams. As shown in diagram 200, a sub-set of 4 receive fine-beams (201, 202, 203, 204) are selected for the 1st stage of beam management.

By receiving and sweeping across these sub-sets of fine-beams, the Rx-UE measures and selects one or more preferred beams. In this case, the Rx-UE selects receive fine-beams 202 and 203 based on a measurement outcome as the preferred beams in the 1st stage of beam management and sweeping. Subsequently, the Rx-UE initiates/triggers a 2nd stage of receive beam sweeping and measurement of SL signal transmitted by the Tx-UE only for the fine-beams (202, 205, 206, 207, 203) that are in-between and including the preferred beams (202 and 203). Then based on the measurement outcome, the Rx-UE performs a final selection of a best beam among the fine-beams (202, 205, 206, 207, 203) for SL communication between the two UEs. In the end, the total number of receive beams that had been measured by the Rx-UE to reach a final selection of the L best beam by the Rx-UE is 4 sub-sampling beams from the 1st stage+5 fine-beams from the 2nd stage=9 total beams. Compare the proposed Exemplary Method 2 to the existing traditional full sweeps of beams, there is a reduction in the sweeping of 4 transmit beams, which is around 31% saving in number of required resources, UE computation processing and time delay. If the supported total number of receive beams is larger than 13, the end saving of resources and processing time would be even higher. For example, if the total number of supported receive beams is 32, the saving would be around 72%.

In summary, in order to minimize the number of resources and the amount of effort to perform receive beam sweeping and beam management in NR sidelink communication, it is proposed in the present disclosure to adopt a principle/approach of “beam sampling”. Based on the “beam sampling” approach, the overall receive beam sweeping and management is separated into two stages/steps of operation. During 1st stage/step of beam management, to initiate/trigger the 1st stage of receive beam management, a sidelink Rx-UE indicates or configures a sidelink Tx-UE a X number of transmissions of a SL signal. If the Tx-UE supports multi-beam transmission (transmit beamforming), the Rx-UE may additionally indicate/configure the Tx-UE a transmit beam index or ID for transmitting the SL signal X number of times. During 2nd stage/step of beam management, to initiate/trigger the 2nd stage of receive beam management to determine a set of one or more best receive beams for receiving SL transmissions from the Tx-UE, the sidelink Rx-UE indicates or configures the Tx-UE a Y number of transmissions of a SL signal. If the Tx-UE supports multi-beam transmission (transmit beamforming), the Rx-UE may additionally indicate/configure the Tx-UE a transmit beam index or ID for transmitting the SL signal Y number of times.

FIG. 7 illustrates a UE 900 for wireless communication according to an embodiment of the present disclosure. The UE 900 includes an executor 901 configured to initiate or trigger a first stage of beam management, where initiating or triggering the first stage of beam management includes the executor 901 indicating or configuring another UE, X number of transmissions of a sidelink (SL) signal, where X is a positive integer. This can solve issues in the prior art, provide a beam management for sidelink communication, minimize/reduce sidelink (SL) resource and UE processing overhead without sacrificing the accuracy/correctness of selecting the best receive beam by a receiver UE (Rx-UE), achieve a more resource efficient beam sweeping and selection process, achieve faster beam selection and reporting, provide a good communication performance, and/or provide high reliability.

In some embodiments, the executor 901 is further configured to determine a set of one or more preferred receive beams for receiving the X number of transmissions of the SL signal from the another UE. In some embodiments, for each one of the X number of transmissions of the SL signal, the executor 901 is configured to use a different receive beam for SL reception and perform a radio measurement on the SL signal for selecting one or more top K preferred beams, where K is a positive integer. In some embodiments, K is configured or pre-defined from a range between 1 and up to 4. In some embodiments, a set of receive beams used by the UE 900 for reception and measurement of the X number of transmissions of the SL signal includes a set of broad-beams or a sub-set of all receive beams.

In some embodiments, initiating or triggering the first stage of beam management is performed periodically for selection of at least one initial receive beam and/or a beam tracking/updating, or event triggered based on a beam failure reporting/consistent beam failure indication, a change in the measurement from using one or more receive beams, and/or radio link failure detection/indication. In some embodiments, the executor 901 is further configured to initiate or trigger a second stage of beam management, where initiating or triggering the second stage of beam management includes the executor 901 indicating or configuring the another UE Y number of transmissions of the SL signal, where Y is a positive integer. In some embodiments, the executor 901 is further configured to determine a set of one or more best receive beams for receiving the Y number of transmissions of the SL signal from the another UE.

In some embodiments, for each one of the Y number of transmissions of the SL signal, the executor 901 is configured to use a different receive beam for SL reception and perform a radio measurement on the SL signal for selecting one or more top L best beams, where L is a positive integer. In some embodiments, L is configured or pre-defined from a range between 1 and up to 4. In some embodiments, the executor 901 is configured to initiate or trigger the second stage of beam management according to one or more of the following conditions/triggers: as part of an initial selection of one or more best receive beams for SL communication between at least two UEs, where the second stage of beam management has not previously been performed by the executor 901; when there is a change in selected one or more top K preferred beams from a past in the first stage of beam management during a beam tracking/updating; and when the executor 901 observes a change in a measurement of one or more selected/currently used best beams from a last/most recently performed second stage of beam management.

In some embodiments, the second stage of beam management is initiated or triggered after the first stage of beam management as part of an initial selection of best beams or when there is a change in the measurements in the first stage of beam management. In some embodiments, the second stage of beam management is initiated or triggered independently from the first stage of beam management or the second stage of beam management is initiated or triggered without having firstly performed the first stage of beam management when there is a change in a measurement during a beam tracking/updating. In some embodiments, the X and/or Y number of transmissions of the SL signal is based on a multi-consecutive slots transmission (MCSt). In some embodiments, the executor 901 is further configured to indicate or configure the another UE a transmit beam index or an identifier (ID) for transmitting the SL signal the X and/or Y number of times.

In some embodiments, the executor 901 indicating or configuring the another UE the X and/or Y number of transmissions of the SL signal includes the executor 901 indicating or configuring the another UE a time and frequency resource, and/or a transmission periodicity for the X and/or Y number of transmissions of the SL signal. In some embodiments, the executor 901 is configured to indicate or configure the another UE the X and/or Y number of transmissions of the SL signal using a PC5 radio resource control (RRC) signaling, a PC5 sidelink control information (SCI) signaling, a physical sidelink feedback channel (PSFCH), and/or a PC5 medium access control (MAC) control element (CE) signaling. In some embodiments, the X and/or Y number of transmissions of the SL signal includes at least one of the followings: a channel state information-reference signal (CSI-RS), a demodulation reference signal (DM-RS), or a sidelink-synchronization signal block (S-SSB). In some embodiments, the one or more preferred beams and/or the one or more best beams are determined based on at least one of the followings: a received power of sidelink channel state information-reference signal (SL CSI-RSRP), a sidelink received signal strength indicator (RSSI), an estimation of 10% block error rate (BLER) of physical sidelink control channel (PSCCH), a sidelink carrier-to-interference ratio (C/I), or a sidelink signal-to-interference noise ratio (SINR).

In some embodiments, the set of broad-beams in the first stage of beam management and receive beams in the second stage of beam management are in different frequency carriers or in a same frequency carrier. In some embodiments, a beam pattern and/or a periodicity of the set of broad-beams in the first stage of beam management are configured or pre-defined. In some embodiments, a receive beam pattern of the sub-set of all receive beams including a periodicity and a sub-sampling gap between the sub-set of all receive beams are configured or pre-defined. In some embodiments, the receive beam pattern of the sub-set of all receive beams are every second, every third, or every fourth receive beams.

Commercial interests for some embodiments are as follows. 1. Solving issues in the prior art. 2. Providing a beam management for sidelink communication. 3. Minimizing/reducing sidelink (SL) resource and UE processing overhead without sacrificing the accuracy/correctness of selecting the best receive beam by a receiver UE (Rx-UE). 4. Achieving a more resource efficient beam sweeping and selection process. 5. Achieving faster beam selection and reporting. 6. Providing good communication performance. 7. Providing high reliability. 5. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, smart watches, wireless earbuds, wireless headphones, communication devices, remote control vehicles, and robots for public safety use, AR/VR device maker for example gaming, conference/seminar, education purposes, smart home appliances including TV, stereo, speakers, lights, door bells, locks, cameras, conferencing headsets, and etc., smart factory and warehouse equipment including IIoT devices, robots, robotic arms, and simply just between production machines. In some embodiments, commercial interest for the disclosed invention and business importance includes lowering power consumption for wireless communication means longer operating time for the device and/or better user experience and product satisfaction from longer operating time between battery charging. Some embodiments of the present disclosure are a combination of “techniques/processes” that can be adopted in 3GPP specification to create an end product. Some embodiments of the present disclosure relate to mobile cellular communication technology in 3GPP NR Releases 17, 18, and beyond for providing direct device-to-device (D2D) wireless communication services.

FIG. 8 is a block diagram of an example system 700 for wireless communication according to an embodiment of the present disclosure. Embodiments described herein may be implemented into the system using any suitably configured hardware and/or software. FIG. 8 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated.

The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate the communication with the wireless network.

In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules.

In some embodiments, some or all of the constituent components of the baseband circuitry, the application circuitry, and/or the memory/storage may be implemented together on a system on a chip (SOC).

The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan.

A person having ordinary skill in the art can use different ways to realize the function for each specific application while such realizations cannot go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the exemplary embodiments, it is understood that the present disclosure is not limited to the disclosed embodiments but is intended to cover various arrangements made without departing from the scope of the broadest interpretation of the appended claims.

What is claimed is:

1. A method for beam management in sidelink communication by a user equipment (UE), comprising:
initiating or triggering a first stage of beam management, by the UE, wherein initiating or triggering the first stage of beam management comprises the UE indicating or configuring another UE X number of transmissions of a sidelink (SL) signal, where X is a positive integer.

2. The method of claim 1, further comprising the UE determining a set of one or more preferred receive beams for receiving the X number of transmissions of the SL signal from the another UE.

3. The method of claim 1, wherein for each one of the X number of transmissions of the SL signal, the UE is configured to use a different receive beam for SL reception and perform a radio measurement on the SL signal for selecting one or more top K preferred beams, where K is a positive integer;
wherein K is configured or pre-defined from a range between 1 and up to 4.

4. The method of claim 1, wherein a set of receive beams used by the UE for reception and measurement of the X number of transmissions of the SL signal comprises a set of broad-beams or a sub-set of all receive beams.

5. The method of claim 1, wherein initiating or triggering the first stage of beam management is performed periodically for selection of at least one initial receive beam and/or a beam tracking/updating, or event triggered based on a beam failure reporting/consistent beam failure indication, a change in the measurement from using one or more receive beams, and/or radio link failure detection/indication.

6. A user equipment (UE), comprising:
a memory;
a transceiver; and
a processor coupled to the memory and the transceiver;
wherein the UE is configured to perform:
initiating or triggering a first stage of beam management, wherein initiating or triggering the first stage of beam management comprises the UE indicating or configuring another UE X number of transmissions of a sidelink (SL) signal, where X is a positive integer.

7. The UE of claim 6, wherein the UE is further configured to perform: initiating or triggering a second stage of beam management, wherein initiating or triggering the second stage of beam management comprises the UE indicating or configuring the another UE Y number of transmissions of the SL signal, where Y is a positive integer.

8. The UE of claim 7, wherein the UE is further configured to perform: determining a set of one or more best receive beams for receiving the Y number of transmissions of the SL signal from the another UE;
wherein for each one of the Y number of transmissions of the SL signal, the UE is configured to use a different receive beam for SL reception and perform a radio measurement on the SL signal for selecting one or more top L best beams, where L is a positive integer;
wherein L is configured or pre-defined from a range between 1 and up to 4.

9. The UE of claim 7, wherein the UE is configured to initiate or trigger the second stage of beam management according to one or more of the following conditions/triggers:
as part of an initial selection of one or more best receive beams for SL communication between at least two UEs, where the second stage of beam management has not previously been performed by the UE;
when there is a change in selected one or more top K preferred beams from a past in the first stage of beam management during a beam tracking/updating; and
when the UE observes a change in a measurement of one or more selected/currently used best beams from a last/most recently performed second stage of beam management;
wherein the second stage of beam management is initiated or triggered after the first stage of beam management as part of an initial selection of best beams or when there is a change in the measurements in the first stage of beam management; or
the second stage of beam management is initiated or triggered independently from the first stage of beam management or the second stage of beam management is initiated or triggered without having firstly performed the first stage of beam management when there is a change in a measurement during a beam tracking/updating.

10. The UE of claim 7, wherein the X and/or Y number of transmissions of the SL signal is based on a multi-consecutive slots transmission (MCSt);
and/or
the X and/or Y number of transmissions of the SL signal comprises at least one of the followings: a channel state information-reference signal (CSI-RS), a demodulation reference signal (DM-RS), or a sidelink-synchronization signal block (S-SSB).

11. The UE of claim 7, wherein the UE is further configured to perform: indicating or configuring the another UE a transmit beam index or an identifier (ID) for transmitting the SL signal the X and/or Y number of times.

12. The UE of claim 7, wherein the UE indicating or configuring the another UE the X and/or Y number of transmissions of the SL signal comprises the UE indicating or configuring the another UE a time and frequency resource, and/or a transmission periodicity for the X and/or Y number of transmissions of the SL signal;
wherein the UE is configured to indicate or configure the another UE the X and/or Y number of transmissions of the SL signal using a PC5 radio resource control (RRC) signaling, a PC5 sidelink control information (SCI) signaling, a physical sidelink feedback channel (PSFCH), and/or a PC5 medium access control (MAC) control element (CE) signaling.

13. The UE of claim 8, wherein the one or more preferred beams and/or the one or more best beams are determined based on at least one of the followings: a received power of sidelink channel state information-reference signal (SL CSI-RSRP), a sidelink received signal strength indicator (RSSI), an estimation of 10% block error rate (BLER) of physical sidelink control channel (PSCCH), a sidelink carrier-to-interference ratio (C/I), or a sidelink signal-to-interference noise ratio (SINR).

14. The UE of claim 7, wherein the set of broad-beams in the first stage of beam management and receive beams in the second stage of beam management are in different frequency carriers or in a same frequency carrier;
and/or
a beam pattern and/or a periodicity of the set of broad-beams in the first stage of beam management are configured or pre-defined.

15. The UE of claim 7, wherein a receive beam pattern of the sub-set of all receive beams including a periodicity and a sub-sampling gap between the sub-set of all receive beams are configured or pre-defined;
wherein the receive beam pattern of the sub-set of all receive beams are every second, every third, or every fourth receive beams.

16. A non-transitory machine-readable storage medium having stored thereon instructions that, when executed by a computer, cause the computer to perform:
initiating or triggering a first stage of beam management, wherein initiating or triggering the first stage of beam management comprises indicating or configuring another UE X number of transmissions of a sidelink (SL) signal, where X is a positive integer.

17. The non-transitory machine-readable storage medium of claim 16, further causing the computer to perform: determining a set of one or more preferred receive beams for receiving the X number of transmissions of the SL signal from the another UE.

18. The non-transitory machine-readable storage medium of claim 16, wherein for each one of the X number of transmissions of the SL signal, the computer is configured to use a different receive beam for SL reception and perform a radio measurement on the SL signal for selecting one or more top K preferred beams, where K is a positive integer;
wherein K is configured or pre-defined from a range between 1 and up to 4.

19. The non-transitory machine-readable storage medium of claim 16, wherein a set of receive beams used by the computer for reception and measurement of the X number of transmissions of the SL signal comprises a set of broad-beams or a sub-set of all receive beams.

20. The non-transitory machine-readable storage medium of claim 16, wherein initiating or triggering the first stage of beam management is performed periodically for selection of at least one initial receive beam and/or a beam tracking/updating, or event triggered based on a beam failure reporting/consistent beam failure indication, a change in the measurement from using one or more receive beams, and/or radio link failure detection/indication
